(19) United States
(12) Patent Application Publication
(10) Pub. No.: US 2025/0155710 A1
(43) Pub. Date: May 15, 2025

(54) OPTICAL COMBINER AND AUGMENTED REALITY DISPLAY DEVICE

(71) Applicant: ELECTRONICS AND TELECOMMUNICATIONS RESEARCH INSTITUTE, Daejeon (KR)

(72) Inventor: Hyun-Eui KIM, Cheongju-si (KR)

(73) Assignee: ELECTRONICS AND TELECOMMUNICATIONS RESEARCH INSTITUTE, Daejeon (KR)

(21) Appl. No.: 18/940,475

(22) Filed: Nov. 7, 2024

(30) Foreign Application Priority Data
Nov. 10, 2023 (KR) 10-2023-0155186
Oct. 11, 2024 (KR) 10-2024-0138841

(51) Int. Cl. G02B 27/01; G02B 27/10

(52) U.S. Cl. CPC G02B 27/0103; G02B 27/1086; G02B 2027/011; G02B 2027/0123

(57) ABSTRACT

Disclosed herein is an optical combiner. The optical combiner includes a substrate made of a transmissive material, and a layer stacked on the substrate to allow a first surface of the layer to come into contact with the substrate, and including multiple unit macro-pixels that are discretely distributed, wherein the optical combiner combines a first light wave that is real-world information transmitted through the substrate with a second light wave that is virtual information incident on a second surface of the layer at an off-axis angle.

### CROSS REFERENCE TO RELATED APPLICATIONS

This application claims the benefit of Korean Patent Application Nos. 10-2023-0155186, filed Nov. 10, 2023 and 10-2024-0138841, filed Oct. 11, 2024, which are hereby incorporated by reference in their entireties into this application.

### BACKGROUND OF THE INVENTION

### 1. Technical Field

The following embodiments relate to an optical combiner and Augmented Reality (AR) display technology.

### 2. Description of the Related Art

An Augmented Reality (AR) display is next-generation interactive display technology that combines the real world with virtual information to provide abundant mixed reality experience to users, and has been developed as a transmissive (transparent) display form such as a Near-Eye Display (NED) and a Head-Up Display (HUD).

In such an AR display, an optical combiner refers to a window for viewing real world images in the field of view of a user while being a means for combining created virtual information with the real-world images. In the AR display, the optical combiner needs to have a transmission characteristic of functionally transmitting real-world light information to the user without distortion and to perform a function of redirecting light waves so that light waves transferred from a projector can be harmoniously combined with external real-world images in order to augment virtual information to the eye of the user.

Therefore, the optical combiner performs selective optical modulation only on light waves that transfer virtual information. Although there are differences depending on a display purpose and structure, such an optical modulation function generally includes an optical function similar to that of a mirror, a lens or a prism.

In order for the AR display to spatially interact more seamlessly with the user, three-dimensional (3D) image reproduction technology is required. The holographic display meets this purpose as technology for modulating the wavefront of light waves to reproduce 3D image information.

As a hologram display device for hologram reconstructed images, a Spatial Light Modulator (SLM) is generally utilized. The size and the Field of View (FOV) of the holographic display device using the SLM are dependent on the Spatial Bandwidth Products (SBP) of the SLM.

However, because the current SLM technology does not satisfy the SBP for commercial holographic display implementation, a lot of research into various types of multiplexing for SBP extension has been conducted.

### SUMMARY OF THE INVENTION

An embodiment is intended to provide an optical combiner for implementing a 3D holographic AR display.

An embodiment is intended to selectively redirect light waves so as to combine a real-world image with virtual information.

An embodiment is intended to overcome the problem of a narrow Field of View (FOV), an eye box, and image distortion of a holographic display.

In accordance with an aspect, there is provided an optical combiner, including a substrate made of a transmissive material, and a layer stacked on the substrate to allow a first surface of the layer to come into contact with the substrate, and including multiple unit macro-pixels that are discretely distributed, wherein the optical combiner combines a first light wave that is real-world information transmitted through the substrate with a second light wave that is virtual information incident on a second surface of the layer at an off-axis angle.

Each of the unit macro-pixels may be formed such that multiple nanoscale unit pixels are clustered and arranged.

The unit macro-pixels may be randomly arranged.

The unit macro-pixels may be arranged to have periodicity.

The unit pixels may optically modulate the second light wave and redirect the modulated second light wave in a certain direction as a propagation direction.

The unit pixels may optically modulate the second light wave to compensate for an optical aberration caused by at least one optical element constituting an imaging system.

Each of the unit pixels may be manufactured as one of a reflective diffraction element made of a metal material, a Volume Holographic Optical Element (VHOE) made of a polymer material, and a metasurface element.

The layer may include multiple unit macro-pixels configured to optically modulate the second light wave, and a transparent area configured to transmit the first light wave, wherein the transparent area is made of a material having a transmittance similar to an average transmittance of light information transmitted through the unit macro-pixels.

The layer may include multiple unit macro-pixels configured to optically modulate the second light wave, and a transparent area configure to transmit the first light wave, wherein the transparent area is made of a material having a refractive index between a refractive index of the substrate and a refractive index of air.

In accordance with another aspect, there is provided an augmented reality display device, including an optical combiner configured to combine a first light wave that is real-world information with a second light wave that is virtual information, wherein the optical combiner includes a substrate made of a transmissive material, and a layer stacked on the substrate to allow a first surface of the layer to come into contact with the substrate, and including multiple unit macro-pixels that are discretely distributed, and wherein the optical combiner combines a first light wave that is transmitted through the substrate with a second light wave that is incident on a second surface of the layer at an off-axis angle.

Each of the unit macro-pixels may be formed such that multiple nanoscale unit pixels are clustered and arranged.

The unit pixels may optically modulate the second light wave and redirect the modulated second light wave in a certain direction as a propagation direction.

Each of the unit pixels may be manufactured as one of a reflective diffraction element made of a metal material, a Volume Holographic Optical Element (VHOE) made of a polymer material, and a metasurface element.

The layer may include multiple unit macro-pixels configured to optically modulate the second light wave, and a transparent area configured to transmit the first light wave, wherein the transparent area is made of a material having a transmittance similar to an average transmittance of light information transmitted through the unit macro-pixels.

The layer may include multiple unit macro-pixels configured to optically modulate the second light wave, and a transparent area configure to transmit the first light wave, wherein the transparent area is made of a material having a refractive index between a refractive index of the substrate and a refractive index of air.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a side view of an optical combiner according to an embodiment;

FIG. 2 is a diagram illustrating an example of a non-periodic unit macro-pixel array of an optical combiner according to a first embodiment; and

FIG. 3 is a diagram illustrating an example of a periodic unit macro-pixel array of an optical combiner according to a second embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

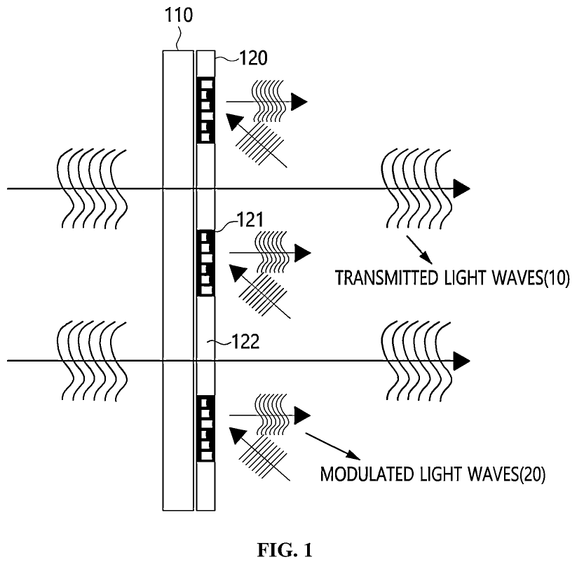

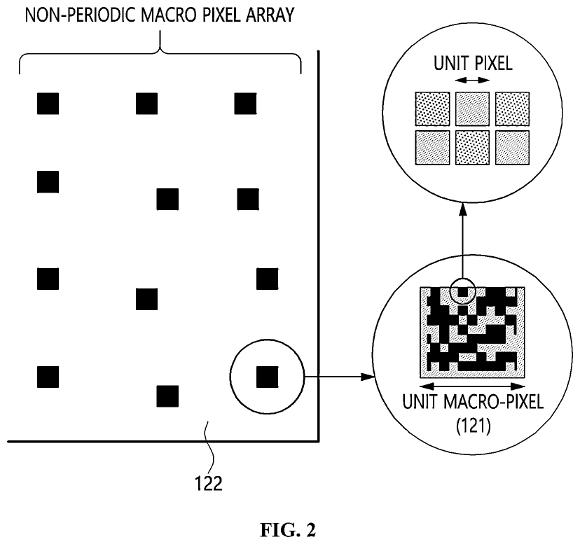

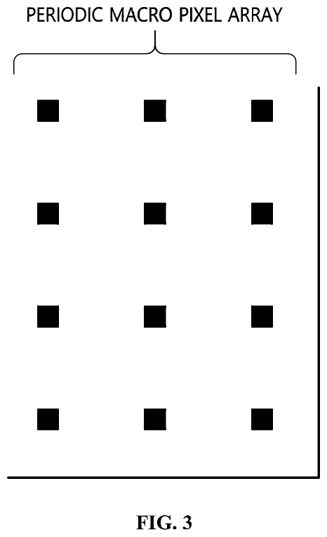

FIG. 1 is a side view of an optical combiner according to an embodiment, FIG. 2 is a diagram illustrating an example of a non-periodic unit macro-pixel array of an optical combiner according to a first embodiment, and FIG. 3 is a diagram illustrating an example of a periodic unit macro-pixel array of an optical combiner according to a second embodiment.

Referring to the optical combiner according to the embodiment may include a substrate 110 made of a transmissive (transparent) material, and a layer 120 which is stacked on the substrate 110 to allow one surface of the layer 120 to come into contact with the substrate 110, and on which multiple unit macro-pixels 121 are discretely distributed.

The optical combiner according to this embodiment is manufactured using semiconductor lithography and imprinting. By means of this, mass production of optical combiners with uniform quality may be facilitated.

The layer 120 according to the embodiment may include the multiple unit macro-pixels 121 that optically modulate second light waves and a transparent area 122 that transmits first light waves.

Here, the multiple unit macro-pixels 121 may be deposited in the form of dots on the layer 120 in a localized area, and may reflect beams that are incident thereon within a wide wavelength range.

Through the optical combiner, first light waves 10, which are real-world information channels, which have been transmitted through the substrate 110 and the transparent area 122, may be combined with second light waves 20, which are redirected after virtual information channels incident on the other surface of the layer 120 at an off-axis angle are modulated.

By means of this, the light waves combined by the optical combiner may be are projected onto a user's eye, and thus an augmented reality screen in which virtual information is superimposed onto real-world information may be displayed.

Such unit macro-pixels 121 may be discretely distributed on the layer 120 either periodically or non-periodically according to an embodiment.

That is, in accordance with an embodiment, as illustrated in FIG. 2, the unit macro-pixels 121 may be non-periodically arranged.

That is, the unit macro-pixels 121 may be arranged such that the degree of dispersion and the standard deviation of each thereof around the center of each of individual areas divided from the area of the substrate 110 are greater than respective preset thresholds.

In this way, the intensity of higher-order terms acting as optical noise may be remarkably reduced by decreasing the periodicity of the unit macro-pixels 121.

That is, according to another embodiment, as shown in FIG. 3, the unit macro-pixels 121 may be periodically arranged.

That is, the intensity of higher-order terms may be rather increased by arranging the unit macro-pixels 121 to have periodicity.

This is based on the fact that respective higher-order terms may function as carrier frequencies having different output angles, and the unit macro pixels 121 may be utilized as a beam splitter which splits information of signals input to the optical combiner into directions of various angles.

Meanwhile, as illustrated in FIG. 2, it can be seen that each of the unit macro-pixels 121 is configured such that multiple nanoscale unit pixels are clustered and arranged.

Here, each of the unit pixels has a nanoscale size to have a higher spatial frequency, and thus the wavefront of a light wave output from each of the unit pixels may propagate at a wide angle.

Such a unit pixel may optically modulate the corresponding second light wave, and may then redirect the modulated second light wave in a certain direction as the propagation direction thereof.

Furthermore, the unit pixels may compensate for optical aberrations caused by at least one optical element that constitutes an imaging system by optically modulating the second light waves.

Here, each unit pixel may be a diffraction element having nanoscale fine patterns enabling multi-layer phase modulation, and may be manufactured as one of elements enabling optical modulation which include a Volume Holographic Optical Element (VHOE) made of a polymer material, a metasurface made of a metal material, etc.

Further, in order to implement optical functions such as the lens, prism and beam splitter of the optical combiner, pattern calculation for each unit macro-pixel area may be performed by setting the physical samples of the corresponding unit pixel at a sample period.

Meanwhile, the transparent area 122 may be made of a material having a transmittance similar to the average transmittance of light information transmitted through the unit macro-pixels 121. By means of this, the optical combiner may be manufactured such that transmission uniformity across the entire area of the optical combiner is relatively consistent.

Therefore, when each of the unit pixels has high reflectivity, the transmission efficiency of the optical combiner may be set to the ratio of a transmission area to the entire area of the optical combiner.

Further, in order to control the transmittance of light information, transferred after being transmitted through the optical combiner, in each of the unit pixels of the optical combiner, the transmittance and reflectance of the corresponding element for each wavelength, the thin film thickness of the corresponding element, and the modulation efficiency of a diffraction pattern may be controlled.

As such a semi-transparent diffraction pattern is recorded in this way, the transmitted light information is blocked by the diffraction pattern area, thus preventing image information from being discontinuously transferred.

Furthermore, the transparent area 122 may be made of an arbitrary transmissive material having a refractive index between the refractive index of the substrate and the refractive index of air.

In addition, it may be possible to configure the transmissive material as another layer covering the unit macro-pixel array. By means of this configuration, the occurrence of optical noise and efficiency deterioration may be reduced by mitigating total reflection of light waves when the light waves are incident on a high refractive material at a high angle between two media having a large refraction difference.

Meanwhile, the optical combiner illustrated in FIGS. 1 to 3 according to embodiments may be utilized for various imaging systems.

In an example, the optical combiner may be utilized as an optical combiner for a transmissive AR display.

Also, when a pattern is generated to have a function of an off-axis parabolic mirror on the optical combiner, it is possible to implement a structure in which light waves transferred from an image projector converge on an arbitrary spatial position to generate an eye box. Accordingly, an imaging optical structure that is capable of arbitrarily adjusting the position and the field of view of an image generated across the optical combiner, the position of the user's eye box, the position of the projector, etc. may be implemented.

Further, the diffraction pattern may compensate for optical aberrations caused by various optical elements constituting the imaging system. Therefore, the quality of a restored image may be improved.

Furthermore, light signals transferred from the display may be respectively input to the unit macro-pixels of the combiner. The input light signals may be coherently diffused in the direction of a wide range while maintaining phase information by nanoscale unit pixels within the unit macro-pixels.

The light waves are modulated by the pattern of a high spatial frequency component formed by the unit pixels, and then output light waves have directionality to perform an intended optical function.

Therefore, the image size, FOV, and eye box of the display may be expanded by controlling an optical field input to the optical combiner.

According to an embodiment, there can be provided an optical combiner for implementing a 3D holographic AR display.

According to an embodiment, light waves may be selectively redirected so as to combine a real-world image with virtual information. That is, because virtual information can be modulated using a diffraction pattern of the optical combiner, an arbitrary imaging optical system for virtual reality can be configured by changing the directionality of input light waves and by implementing optical functions such as deflection, convergence, branching, and optical aberration compensation in an arbitrary direction.

According to an embodiment, the problem of a narrow Field of View (FOV), an eye box, and image distortion of a holographic display may be overcome.

According to an embodiment, because the optical combiner, which is a flat optical element, is much thinner than a typical optical combiner having aspheric curvature and is capable of implementing complex optical functions, a compact display optical system may be configured.

Although the embodiment of the present invention has been disclosed, those skilled in the art will appreciate that the present invention can be implemented as other concrete forms, without departing from the scope and spirit of the invention as disclosed in the accompanying claims. Therefore, it should be understood that the exemplary embodiment is only for illustrative purpose and do not limit the scope of the present disclosure.

What is claimed is:

1. An optical combiner, comprising:
a substrate made of a transmissive material; and
a layer stacked on the substrate to allow a first surface of the layer to come into contact with the substrate, and including multiple unit macro-pixels that are discretely distributed,
wherein the optical combiner combines a first light wave that is real-world information transmitted through the substrate with a second light wave that is virtual information incident on a second surface of the layer at an off-axis angle.

2. The optical combiner of claim 1, wherein each of the unit macro-pixels is formed such that multiple nanoscale unit pixels are clustered and arranged.

3. The optical combiner of claim 1, wherein the unit macro-pixels are randomly arranged.

4. The optical combiner of claim 1, wherein the unit macro-pixels are arranged to have periodicity.

5. The optical combiner of claim 2, wherein the unit pixels optically modulate the second light wave and redirect the modulated second light wave in a certain direction as a propagation direction.

6. The optical combiner of claim 2, wherein the unit pixels optically modulate the second light wave to compensate for an optical aberration caused by at least one optical element constituting an imaging system.

7. The optical combiner of claim 2, wherein each of the unit pixels is manufactured as one of a reflective diffraction element made of a metal material, a Volume Holographic Optical Element (VHOE) made of a polymer material, and a metasurface element.

8. The optical combiner of claim 1, wherein the layer comprises:
multiple unit macro-pixels configured to optically modulate the second light wave; and
a transparent area configured to transmit the first light wave,
wherein the transparent area is made of a material having a transmittance similar to an average transmittance of light information transmitted through the unit macro-pixels.

9. The optical combiner of claim 1, wherein the layer comprises:
multiple unit macro-pixels configured to optically modulate the second light wave; and
a transparent area configure to transmit the first light wave,
wherein the transparent area is made of a material having a refractive index between a refractive index of the substrate and a refractive index of air.

10. An augmented reality display device, comprising:
an optical combiner configured to combine a first light wave that is real-world information with a second light wave that is virtual information,
wherein the optical combiner comprises:
a substrate made of a transmissive material; and
a layer stacked on the substrate to allow a first surface of the layer to come into contact with the substrate, and including multiple unit macro-pixels that are discretely distributed, and
wherein the optical combiner combines a first light wave that is transmitted through the substrate with a second light wave that is incident on a second surface of the layer at an off-axis angle.

11. The augmented reality display device of claim 10, wherein each of the unit macro-pixels is formed such that multiple nanoscale unit pixels are clustered and arranged.

12. The augmented reality display device of claim 11, wherein the unit pixels optically modulate the second light wave and redirect the modulated second light wave in a certain direction as a propagation direction.

13. The augmented reality display device of claim 11, wherein each of the unit pixels is manufactured as one of a reflective diffraction element made of a metal material, a Volume Holographic Optical Element (VHOE) made of a polymer material, and a metasurface element.

14. The augmented reality display device of claim 10, wherein the layer comprises:
multiple unit macro-pixels configured to optically modulate the second light wave; and
a transparent area configured to transmit the first light wave,
wherein the transparent area is made of a material having a transmittance similar to an average transmittance of light information transmitted through the unit macro-pixels.

15. The augmented reality display device of claim 10, wherein the layer comprises:
multiple unit macro-pixels configured to optically modulate the second light wave; and
a transparent area configure to transmit the first light wave,
wherein the transparent area is made of a material having a refractive index between a refractive index of the substrate and a refractive index of air.
